(19) United States
(12) Patent Application Publication
(10) Pub. No.: US 2026/0336938 A1
(43) Pub. Date: Oct. 29, 2026

(54) METHOD FOR ENERGY STORAGE VIA SUBTERRANEAN FORMATION FRACTURES BASED ON COMPRESSED AIR AND SYSTEM THEREOF

(71) Applicant: Chongqing University, Chongqing (CN)

(72) Inventor: Hanyi WANG, Chongqing (CN)

(73) Assignee: Chongqing University, Chongqing (CN)

(21) Appl. No.: 19/296,204

(22) Filed: Aug. 11, 2025

(30) Foreign Application Priority Data
Apr. 23, 2025 (CN) 202510513686.2

(51) Int. Cl. B65G 5/00; E21B 43/267

(52) U.S. Cl. CPC B65G 5/005; E21B 43/267

(57) ABSTRACT

The present application relates to a method for energy storage via subterranean formation fractures based on compressed air and system thereof, comprising the steps of: constructing one or more subterranean formation fractures; sealing pores and/or micro-fractures in the surrounding rock adjacent to the one or more subterranean formation fractures; verifying the air tightness of the one or more subterranean formation fractures; injecting compressed air into a target wellbore for energy storage; and releasing stored energy by reversing and discharging the compressed air. It not only accumulates potential energy from air compression but also stores stress potential energy and elastic potential energy from rock deformation while capturing geothermal energy from the formation. Most significantly, the method is not geographically restricted, enabling subsurface compressed air energy storage to be implemented in any location, thereby substantially expanding the applicability and deployment scope of compressed air energy storage technologies.

### CROSS-REFERENCE TO RELATED APPLICATIONS

The present application claims the benefit and priority of Chinese invention patent application No. 202510513686.2, filed on Apr. 23, 2025, the disclosure of which is incorporated herein by reference in its entirety as part of the present application.

### TECHNICAL FIELD

The present application relates to the technical field of subsurface energy storage, particularly relates to a method for energy storage via subterranean formation fractures based on compressed air and system thereof.

### BACKGROUND

Many renewable energy sources such as solar and wind energy exhibit daily and seasonal intermittency, with unstable power output that makes them unsuitable for providing base-load power supply. As a result, they are difficult to be directly integrated into the power grid. Solving the energy storage problem is the key to successfully expanding the scale of renewable energy production. Therefore, how to store excess clean electricity on a large scale and stably transmit electricity when sunlight and wind supply are insufficient remains a technical challenge that countries around the world are striving to tackle.

As a mature energy storage technology, Compressed Air Energy Storage (CAES) boasts advantages such as large storage capacity, long service life, and strong stability. However, it has high requirements for geographical conditions, needing abandoned mines or underground caverns as air storage media, thus being usable only in certain specific regions. Although artificial underground cavities are currently also used as air storage media, their extremely high construction and investment costs have greatly restricted the commercial prospects of compressed air energy storage.

Although depleted oil and gas reservoirs can serve as potential sites for compressed air energy storage, they also have significant limitations: 1) The rock formations of depleted oil and gas reservoirs, which have typically undergone long-term oil and gas production, may contain fractures, faults, and high-permeability channels. This makes it easy for air to leak into surrounding formations or the surface, affecting gas storage efficiency and environmental safety. 2) Due to long-term production, the formations of depleted oil and gas reservoirs may have deformed or compacted, reducing the mechanical integrity of the gas storage reservoir. Under high-pressure conditions, formation collapse or slippage may occur, compromising the safety of the gas storage reservoir. 3) There may be a certain amount of residual oil and gas in depleted oil and gas reservoirs. These residues may mix with compressed air and undergo unpredictable chemical reactions, potentially leading to safety hazards (such as explosions or fires). 4) The rock formations of depleted oil and gas reservoirs usually have high permeability, which, while beneficial for oil and gas extraction, is unfavorable for maintaining high pressure during gas storage, resulting in high air leakage rates and reduced long-term operational efficiency. 5) Long-term production from depleted oil and gas reservoirs reduces the rock pore pressure, thereby lowering the formation fracture pressure. As a result, the formations struggle to withstand high pressures, limiting energy storage capacity and efficiency.

The prior art Chinese patent CN117722132A discloses a method and product for transforming a depleted gas reservoir into a compressed air storage reservoir, which includes: selecting an abandoned well in the depleted gas reservoir as a base well; drilling several expansion holes on the wellbore of the selected base well to expand the base well; injecting fracturing fluid into the wellbore to fracture all the expansion holes for further expansion of the base well; when the power generation is large, using the excess electric energy to compress air into the expanded base well for energy storage; when the power generation is small, releasing the air stored in the base well to displace the generator for power generation.

The limitations of the above-mentioned prior art are as follows: (1) It requires drilling branch wellbores, resulting in high costs; (2) Although the energy storage space is expanded through hydraulic fracturing, the extent of fracture expansion during fracturing is constrained by the branch wells; (3) There is no restriction on the fracture pressure during energy storage, which may lead to situations where the energy storage pressure is too low to open the fractures or too high to cause fracture propagation; (4) It does not reduce the permeability of the reservoir in depleted gas reservoirs, so the injected compressed air is prone to diffuse to distant areas through the reservoir pores.

The Chinese patent application with publication number CN119288417 discloses a multi-well energy storage and release method and system, which includes: selecting at least two wellbores hydraulically connected through formation fractures and/or rock pores as wellbores for energy storage and/or release; during energy storage, injecting high-pressure fluid into one or several of the wellbores, sealing the wellbores, and maintaining the elastic deformation of formation rocks for energy storage; during energy release, reducing the wellbore sealing pressure to allow one or several of the wellbores to reverse-discharge the high-pressure fluid, and obtaining energy to generate electricity during the reverse-discharge process. However, the limitations of this method are as follows: (1) It requires the cooperation of multiple wells, and a single well cannot independently complete energy storage or other construction processes; (2) Formation fractures extending from different wellbores are interlaced with each other, which is likely to form a complex fracture network, being unfavorable for energy storage efficiency and fluid loss prevention; (3) During energy storage, there is no restriction on fracture pressure, allowing fracture propagation, which easily leads to the loss of energy storage fluid; (4) Using formation rock pores for energy storage makes it difficult to control the diffusion of the energy storage fluid.

The Chinese patent application with publication number CN114016988A discloses a method and system for energy storage and release through formations. The method involves performing hydraulic fracturing operations in an energy storage formation without oil or gas to generate at least one formation fracture. Then, high-pressure liquid is injected into the obtained formation fracture to cause elastic deformation of the formation fracture for energy storage. Subsequently, the high-pressure liquid in the fracture is reverse discharged to drive a preset hydroelectric power generation device for energy release. The Chinese patent application with publication number CN118654399A discloses a method and system for energy storage, energy release and geothermal energy acquisition through formation fractures. The system includes a fracturing device, which is used to pump fracturing fluid into the wellbore to generate formation fractures in the energy storage geothermal layer; an injection pipeline, on which injection equipment is connected; a reverse-discharge pipeline, on which hydroelectric power generation equipment, geothermal power generation equipment and a heating system are connected, so that when the fluid in the formation fractures is reversely discharged through the reverse discharge pipeline, it can displace the hydroelectric power generation equipment and geothermal power generation equipment to generate electricity and provide heating through the heating system; and a sealing device, which is used to close the reverse discharge pipeline so that the fluid in the formation fractures can continuously exchange heat with the energy storage geothermal layer, resulting in a continuous increase in the fluid temperature. This technology utilizes the elastic deformation of formation fractures for energy storage and release, and at the same time uses geothermal resources for power generation and/or heating. The limitations of the above method are as follows: (1) It only recovers the elastic deformation energy of formation rocks, so it is only suitable for recovering the kinetic energy of incompressible liquids, which greatly limits its output power. Moreover, this method is not suitable for compressed air energy storage, because the main way of compressed air energy storage is through the compressive potential energy accumulated by air; (2) The disclosed method only uses liquids to exchange heat with the formation, and does not provide any disclosure on how to use compressed air to exchange with the formation to obtain thermal energy; (3) It does not consider the treatment methods for the significant changes in volume and pressure caused by the heating of compressed air in the formation; (4) Due to the huge differences in properties between liquids and compressed air, for example, because air has a lower viscosity than liquids (air is 50 times less viscous than water) and is more prone to leakage, those skilled in the art cannot obtain enlightenment on judging the air tightness of formation fractures from the disclosed method.

In view of this, there is an urgent need for a compressed air-based energy storage method that features low investment and construction costs, can complete energy storage and release using a single well, and is not restricted by geographical conditions.

### SUMMARY

In view of the above, the present application provides a method for energy storage via subterranean formation fractures based on compressed air and system thereof. This method and system are not constrained by geographical conditions and enables subsurface compressed air energy storage implementation in any location, thereby significantly expanding the application scope of compressed air energy storage technology.

In first aspect of the present application, discloses a method for energy storage via subterranean formation fractures based on compressed air, comprising the steps of:
S1, injecting a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via the one or more subterranean formation fractures, that is, the target wellbore is not connected to other wellbores via formation fractures, which can be understood as a single independent wellbore,
S2, injecting a sealing fluid into the one or more subterranean formation fractures to physically and/or chemically seal pores and/or micro-fractures in the surrounding rock of the one or more subterranean formation fractures,
S3, conducting an air tightness test based on wellhead sealing on the target wellbore to determine air tightness of the one or more subterranean formation fractures,
S4, injecting compressed air into the target wellbore and the one or more subterranean formation fractures, and making post-injection pressure of the one or more formation fractures greater than a fracture closure pressure but less than a fracture propagation pressure to store energy, which at least includes compressive potential energy accumulated by the compressed air due to pressure increase in overall space formed by the target wellbore and the one or more subterranean formation fractures,
S5, monitoring whether there is a demand for energy release, if no demand exists, sealing the wellhead; if demand exists, reverse-discharging the compressed air, and obtaining at least the compressive potential energy released by the compressed air during the reverse-discharge process.

According to the method disclosed in the first aspect of the present application, the sealing fluid is configured as a fracturing liquid fluid containing sealing substance, enabling step S2 to be integrated into step S1 and performed simultaneously with step S1, or, the sealing fluid is configured as a liquid fluid containing sealing substance and independent of the fracturing fluid, enabling step S2 to be performed independently of step S1.

According to the method disclosed in the first aspect of the present application, a thickening agent is added to the fracturing liquid fluid, and the thickening agent comprises at least one selected from the group consisting of: at least one natural polymer or its derivatives, at least one cellulose or its derivatives, at least one synthetic polymer, at least one surfactant-based thickener, at least one gel-based thickener, and at least one clay.

According to the method disclosed in the first aspect of the present application, the sealing substance comprises a solid sealing substance for physically sealing pores and/or micro-formation fractures in the surrounding rock of the formation fractures.

In another embodiment, the sealing substance comprises a liquid sealing substance configured to undergo a curing or gelation reaction between its own components, or between different liquid sealing substances upon contact, or with fluids in the pores and/or micro-fractures in the surrounding rock of the one or more subterranean formation fractures upon contact, or to undergo a curing or gelation reaction due to changes in salinity, pH, or temperature after entering the subterranean formation, so as to chemically seal the pores and/or micro-fractures in the surrounding rock of the subterranean formation fractures.

In a specific embodiment, the sealing substance can include both the solid sealing substance and liquid sealing substance.

According to the method disclosed in the first aspect of the present application, the sealing substance is directly added to corresponding fluid constituting the sealing fluid. In another embodiment, the sealing material in fluid is added to the corresponding fluid constituting the sealing fluid in a manner that at least part of the sealing substance is encapsulated in degradable capsule.

According to the method disclosed in the first aspect of the present application, step S3 comprises:
S301, injecting a high-pressure fluid into the target wellbore such that a pressure within the one or more subterranean formation fractures is greater than the fracture closure pressure and less than the fracture propagation pressure, so as to the one or more subterranean formation fractures are in an open and non-propagating state,
S302, sealing the wellhead of the target wellbore,
S303, determining whether the one or more subterranean formation fractures gradually close under a wellhead sealing condition by monitoring the change in pressure at the wellhead and/or in the wellbore over time, thereby determining the air tightness of the formation fractures.

According to the method disclosed in the first aspect of the present application, in the step S3, the high-pressure fluid comprises a high-pressure liquid fluid and a high-pressure gas fluid, steps S301-S303 are first performed based on the high-pressure liquid fluid and then based on the high-pressure gas fluid in sequence.

According to the method disclosed in the first aspect of the present application, in the step S301, a test pressure threshold is set, which is configured to be greater than the fracture closure pressure and less than the fracture propagation pressure, such that after the high-pressure fluid is injected into the one or more subterranean formation fractures, a maximum pressure in formation fractures is not lower than the test pressure threshold and less than the fracture propagation pressure.

According to the method disclosed in the first aspect of the present application, in step S303, the determination of air tightness of the one or more subterranean formation fractures comprises:
monitoring temperature at the wellhead and/or within the wellbore when the wellhead is sealed, and recording a start time when the temperature at the wellhead and/or within the wellbore no longer changes as time t₀,
starting from time t₀ or a time after t₀, determining the air tightness of the one or more subterranean formation fractures based on the change in pressure at the wellhead and/or in the wellbore over time.

According to the method disclosed in the first aspect of the present application, during the execution of step S4, the method further comprises a step of monitoring pressure at the wellhead and/or within the wellbore and a flow rate of compressed air. By monitoring the pressure at the wellhead and/or in the wellbore as well as the flow rate of compressed air, fracture pressure can be calculated, thereby ensuring that the fracture pressure does not exceed the set value.

According to the method disclosed in the first aspect of the present application, in step S5, after sealing the wellhead upon monitoring no demand for energy release, the method further comprises a step of monitoring pressure at the wellhead and/or within the wellbore to calculate pressure in the one or more subterranean formation fractures,

1reverse-discharging the compressed air from the target wellbore when the pressure in the one or more subterranean formation fractures approaches or reaches the formation fracture propagation pressure or a set fracture working pressure threshold.

According to the method disclosed in the first aspect of the present application, the method further comprising the step of ensuring the one or more subterranean formation fractures still have a residual fracture width after energy release in step S5, which comprises:
setting a critical residual fracture width for the one or more subterranean formation fractures,
determining a critical residual compressed air volume based on the set critical residual fracture width,
in step S5, monitoring the remaining volume of the compressed air in the wellbore and its formation fractures during the energy release process, and ending the reverse-discharge when the monitored remaining volume approaches or reaches the critical residual compressed air volume, thereby retaining a residual fracture width in the formation fractures. The remaining volume of compressed air can also be determined by monitoring the accumulative reverse-discharged volume of compressed air.

According to the method disclosed in the first aspect of the present application, in step S5, a power generation device capable of converting the compressive potential energy of the compressed air into electrical energy is provided.

According to the method disclosed in the first aspect of the present application, during the energy storage in step S4 and the energy release in step S5, the energy further comprises at least one of the following: the stress potential energy accumulated by the compressed air doing work against the fracture closure pressure, the elastic deformation potential energy accumulated by driving the formation rock to undergo elastic deformation, and the formation thermal energy obtained by the heat exchange between the compressed air in the one or more subterranean formation fractures and the formation rock.

According to the method disclosed in the first aspect of the present application, the method further includes the step of modifying tips of the one or more subterranean formation fractures, comprising:
sequentially injecting a first fluid and a second fluid into the one or more subterranean formation fractures, and the first fluid comprises at least one liquid polymer and at least one curing agent, and the second fluid is configured as a fluid that does not undergo a curing reaction or polymerization reaction by itself,
after the second fluid displaces the first fluid to the tips of the one or more subterranean formation fractures, ceasing the injection of the second fluid into the one or more subterranean formation fractures, and until the first fluid completes the curing reaction, transitioning from a liquid-state substance to a solid-state substance.

By means of the step of performing fatigue repair on fracture tips, the risk of fatigue effects occurring at the fracture tips can be effectively reduced. This further avoids the occurrence of micro-fractures caused by fatigue effects at the fracture tips due to repeated opening and closing of formation fractures, thereby preventing compressed air from leaking at the fracture tips.

It should be particularly emphasized that the step of modifying the tips of formation fractures is carried out before energy storage, aiming to prevent cracks caused by tip fatigue after energy storage and release operations (since the fractures need to undergo a great number of opening and closing cycles), that is, to achieve the purpose of advance prevention.

Further, fracture toughness of the solid-state substance is greater than the fracture toughness of the formation rock in which the one or more subterranean formation fractures are located, and/or tensile strength of the solid-state substance is greater than the tensile strength of the formation rock in which the one or more subterranean formation fractures are located, and/or shear strength of the solid-state substance is greater than the shear strength of the formation rock in which the one or more subterranean formation fractures are located, and/or compressive strength of the solid-state substance is greater than the compressive strength of the formation rock in which the subterranean formation fractures are located, and/or fatigue life of the solid-state substance is greater than the fatigue life of the formation rock in which the one or more subterranean formation fractures are located, and/or fatigue limit of the solid-state substance is greater than the fatigue limit of the formation rock in which the one or more subterranean formation fractures are located, and/or fatigue strength of the solid-state substance is greater than the fatigue strength of the formation rock in which the one or more subterranean formation fractures are located.

Further, a ratio M of the viscosity of the first fluid to the viscosity of the second fluid does not exceed 10. This enables the second fluid to have a better displacement effect on the first fluid in the formation fractures and wellbore, avoids the occurrence of viscous fingering, reduces the residual of the first fluid in areas beyond the fracture tips, and prevents the first fluid and the second fluid from mixing in the wellbore.

Further, the density of the first fluid is no less than 70% of the density of the second fluid. This can effectively prevent the Rayleigh-Taylor instability phenomenon caused by the different densities of the first fluid and the second fluid in the wellbore, as well as the stratification of the first fluid and the second fluid in the formation fractures.

In another embodiment, the method further comprises a step of modifying tips of the one or more subterranean formation fractures, comprising:
injecting degradable capsules and a third fluid into the one or more subterranean formation fractures, and the degradable capsules encapsulate at least one reactant, and the third fluid is configured as a fluid that does not undergo a solidification or polymerization reaction itself,
after stopping the injection of the degradable capsules, continuing to inject the third fluid to displace the degradable capsules to the tips of the one or more subterranean formation fractures,
after the displacing work is completed, the degradable capsules degrade at the fracture tips of the formation fractures, causing the reactants released by the degradable capsules to undergo a curing reaction with each other and/or with the third fluid, so as to form a solid-state substance.

Further, in the step of injecting degradable capsules and a third fluid into the one or more subterranean formation fracture, the density of the degradable capsules is configured to be less than that of the third fluid, such that the degradable capsules aggregate along an upper boundary of the one or more subterranean formation fracture, or, in the step of injecting degradable capsules and a third fluid into the one or more subterranean formation fracture, the density of the degradable capsules is configured to be greater than that of the third fluid, such that the degradable capsules aggregate along a lower boundary of the one or more subterranean formation fracture. This makes it possible to adjust the different positions where the capsules gather in the formation fractures by changing the density of the degradable capsules, thereby effectively modifying the specific positions of the fracture tips of the formation fractures.

Further, a single degradable capsule can encapsulate different reactants, or different reactants are encapsulated in different degradable capsules.

In second aspect of the present application, discloses a system for implementing the method according to the first aspect of the present application, comprising:
a fracturing unit configured to inject a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via formation fractures,
a sealing fluid injection unit configured to injecting a sealing fluid into the subterranean formation fractures to physically and/or chemically seal pores and/or micro-fractures in the surrounding rock of the one or more subterranean formation fractures,
an air tightness test unit configured to conduct an air tightness test based on wellhead sealing on the target wellbore to evaluate the air tightness of the subterranean formation fractures, the air tightness test unit comprises:
a high-pressure fluid injection unit configured to inject high-pressure fluid into the target wellbore such that the pressure in the formation fractures is greater than the fracture closure pressure and less than the fracture propagation pressure, so as to keep the formation fractures open but not expanding,
a sealing unit configured to plug wellhead of the target wellbore,
a pressure monitoring and determination unit configured to monitor the wellhead or wellbore pressure of the target wellbore, and determine whether the one or more subterranean formation fractures gradually close under the wellhead sealing condition by monitoring the change in pressure at the wellhead and/or in the wellbore over time, thereby determining the air tightness of the formation fractures,
an energy storage unit configured to inject compressed air into the target wellbore such that the post-injection pressure of the one or more subterranea formation fractures is greater than the fracture closure pressure and less than the fracture propagation pressure for energy storage, which at least includes the compressive potential energy accumulated by the compressed air due to the pressure increase in the overall space formed by the target wellbore and the one or more subterranea formation fractures,
an energy release unit configured to reverse-discharge the compressed air and obtain at least the compressive potential energy released by the compressed air during the reverse-discharge process,
wherein the sealing fluid is configured as a fracturing fluid containing sealing substances, enabling the sealing fluid injection unit to be integrated into the fracturing unit and complete the work along with the fracturing operation, or the sealing fluid is configured as a fluid containing sealing substances and independent of the fracturing fluid, enabling the sealing fluid injection unit to work independently of the fracturing unit.

Beneficial effect: in the present application, the method and the system for energy storage via subterranean formation fractures based on compressed air of the present application enable the creation of sealed artificial subterranean fractures for energy storage. During operation, the system not only accumulates compressional potential energy of compressed air but also stores stress potential energy by overcoming fracture closure pressure and elastic deformation potential energy by inducing elastic deformation of the formation rock. Additionally, thermal exchange between the compressed air and formation rock captures geothermal energy. Most significantly, the method is not constrained by geographical conditions, enabling subsurface compressed air energy storage in any location and substantially expanding the applicability of compressed air energy storage technology.

### BRIEF DESCRIPTION OF THE DRAWINGS

The method and the system for energy storage via subterranean formation fractures based on compressed air are disclosed in detail below in conjunction with the embodiments shown in the accompanying drawings and the accompanying markings.

FIG. 1 shows a step flowchart of the method for energy storage via subterranean formation fractures based on compressed air, as disclosed in the present application.

FIG. 2 is a schematic diagram of compressed air energy storage via a sealed subterranean formation fracture according to some embodiments of the present application.

FIG. 3 shows a comparison between conventional compressed air energy storage (utilizing natural or man-made subsurface cavities) and compressed air energy storage via sealed subterranean formation fractures.

### DETAILED DESCRIPTION OF THE EMBODIMENTS

It is specifically noted that the term “liquid fluid” as used herein refers to, but is not limited to, liquids, emulsions, slurries, and solid particle flows exhibiting flow characteristics analogous to those of liquids. Similarly, the term “fluid” as used herein encompasses, but is not limited to, gases, liquids, emulsions, slurries, and solid particle flows possessing flow properties comparable to those of liquids.

As used herein, the term “formation” refers to subsurface porous and permeable rock layers (e.g., shale formations, sandstone formations, carbonate formations, hot dry rock formations, etc.) capable of serving as storage spaces for fluids. Such fluids are typically included, but are not limited to, water, hydrocarbons, or gases.

The terms “hydraulic fracturing,” or “fracturing” as used herein refer to the creation and propagation of cracks in formation rock under external forces (e.g., high-pressure fluids).

The terms “subterranean fracture” or “fracture” as used herein denote rock openings created in a formation during hydraulic fracturing operations or naturally occurring fractures or fault fissures inherently present in the formation. The terms “geological fracture”, “formation fracture”, “subterranean fracture” and “fracture” are interchangeable. A “fracture” may refer to a subterranean fracture or multiple adjacent fractures or fracture swarms at the same location.

The term “wellbore” as used herein refers to a borehole drilled or inserted into a formation via a conduit. Typically, the wellbore is cylindrical, though its cross-section may be circular or any other shape. The wellbore may be an open-hole wellbore (uncased) or a cased wellbore (with cemented casing along its inner wall). The wellbore may be vertical, horizontal, or inclined.

The term “fracture closure pressure” as used herein refers to the minimum pressure required to keep a fracture open, equivalent to the in-situ stress perpendicular to the fracture plane, typically corresponding to the formation's minimum principal stress. For horizontal fractures, the fracture closure pressure generally equals the vertical principal stress of the formation. For vertical fractures, it typically equals the formation's minimum horizontal principal stress.

The terms “fracture pressure” or “pressure within the fracture” as used herein refer to the average pressure within a subterranean fracture. The fracture pressure may be determined by monitoring wellhead pressure (e.g., fracture pressure =wellhead pressure +hydrostatic pressure −frictional loss) or by measuring pressure within the wellbore. A wellbore flow model may be employed to calculate the dynamic correlation between wellhead pressure and fracture pressure under varying injection rates and fluid density/temperature conditions.

The term “fracture propagation pressure” as used herein refers to the pressure at which a subterranean fracture begins to propagate in length or height direction, typically exceeding the “fracture closure pressure.” The fracture propagation pressure may be determined through empirical formulas, rock mechanics models, logging data, numerical modeling, or the like, or via field measurements (e.g., diagnostic fracturing injection testing, formation integrity testing, mini-frac testing, step-rate testing, etc.).

The technical solutions of the embodiments of the present application will now be described clearly and completely with reference to the accompanying drawings and the definitions provided above. It is evident that the embodiments described are merely a subset of the present application and do not represent all possible embodiments. Any other embodiments derived by those of ordinary skill in the art, without involving inventive effort, shall fall within the scope of protection of the present application.

It should be noted that the embodiments and features thereof described in this application may be combined in non-conflicting manners.

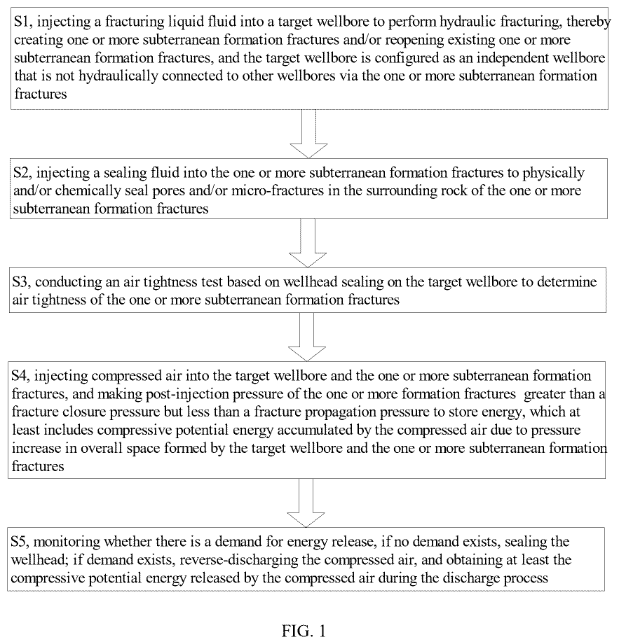

FIG. 1 shows a step flowchart of the method for energy storage via subterranean formation fractures based on compressed air, as disclosed in the present application. As shown in FIG. 1, the application provides a method for energy storage via subterranean formation fractures based on compressed air, comprising the following steps:
S1, injecting a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via the one or more subterranean formation fractures,
S2, injecting a sealing fluid into the one or more subterranean formation fractures to physically and/or chemically seal pores and/or micro-fractures in the surrounding rock of the one or more subterranean formation fractures,
S3, conducting an air tightness test based on wellhead sealing on the target wellbore to determine air tightness of the one or more subterranean formation fractures,
S4, injecting compressed air into the target wellbore and the one or more subterranean formation fractures, and making post-injection pressure of the one or more formation fractures greater than a fracture closure pressure but less than a fracture propagation pressure to store energy, which at least includes compressive potential energy accumulated by the compressed air due to pressure increase in overall space formed by the target wellbore and the one or more subterranean formation fractures,
S5, monitoring whether there is a demand for energy release, if no demand exists, sealing the wellhead; if demand exists, reverse-discharging the compressed air, and obtaining at least the compressive potential energy released by the compressed air during the reverse-discharge process.

In step S1, the subterranean fractures serve as the primary energy storage medium. The target wellbore may be a newly drilled storage wellbore or a repurposed abandoned wellbore. The wellbore may be vertical or horizontal. For abandoned oil/gas wells, unwanted perforations must be permanently sealed or isolated. If pre-existing hydraulic fractures (e.g., in depleted shale oil/gas wells) are utilized, it is typically necessary to either recover the proppant or enlarge the original fracture area to mitigate the adverse effects of proppant on energy storage (proppant impedes fracture closure, thereby reducing storage capacity and efficiency). Alternatively, abandoned wells may undergo refracturing to create new proppant-free subterranean fractures. Multiple subterranean fractures may be generated at different locations along the wellbore.

It is specifically noted that in the present application, the target wellbore is configured as a single, independent wellbore that is not in hydraulical communication with any other wellbores via subterranean fractures, as such connectivity would significantly compromise fracture propagation and sealing integrity.

Additionally, the depth of hydraulic fracturing and the size of subterranean fractures may be designed based on the required energy storage capacity. For pre-existing subterranean fractures (e.g., prior hydraulic fractures or natural fractures), their length or height may be extended to meet design specifications.

Furthermore, in the method disclosed in this embodiment, a thickening agent is added to the fracturing liquid fluid in step S1 to increase its viscosity.

In the context of “wellhead sealing condition” in Step S3 and “monitoring whether there is a demand for energy release, if no demand exists, sealing the wellhead” in Step S5, the term “sealing the wellhead” refers to a condition where compressed air does not enter or exit the target wellbore. It is important to note that in Step S4, compressed air can be injected into the wellbore via a compressed air injection device (e.g., a compressed air injection pipe) that extends from the wellhead into the wellbore. This process also involves wellhead sealing, however, in this case, the sealing does not restrict the injection of compressed air into the target wellbore. Specifically, the wellhead sealing in Step S4 refers to sealing the gap between the wellhead and the compressed air injection device to ensure that compressed air is injected into the wellbore under high pressure. Similarly, it should be emphasized that in Step S5, the “sealing the wellhead” in “monitoring whether there is a demand for energy release, if no demand exists, sealing the wellhead” does not preclude the subsequent operation of reverse-discharging compressed air in the event that there is an energy release demand. The “reverse-discharging of the compressed air” can be achieved through a compressed air reverse-discharge device (e.g., a flowback pipe) that passes through the sealing device used to seal the wellhead.

Typically, lower fracturing fluid viscosity facilitates communication with natural fractures, formation weak planes, or faults, forming complex fracture networks. Conventional hydraulic fracturing operations (e.g., for shale oil/gas, tight oil/gas, or coalbed methane) often employ low-viscosity fluids to create complex fracture networks for enhanced hydrocarbon recovery. In some cases, ultra-low-viscosity fluids (e.g., supercritical carbon dioxide) are used to further increase fracture network complexity. However, complex fracture networks are disadvantageous for energy storage, as they reduce fracture pressure-bearing capacity and fracture width. To minimize fracture complexity and prevent excessive branching (which would impair storage efficiency and capacity), a thickening agent is added to the fracturing liquid fluid during hydraulic fracturing to suppress the risk of complex fracture formation.

In the method disclosed herein, the thickening agent includes but is not limited to one or more of the following: at least one natural polymer or its derivatives, at least one cellulose or its derivatives, at least one synthetic polymer, at least one surfactant-based thickener, at least one gel-based thickener, at least one clay. Specifically, the thickening agent may be selected from: natural polymers and its derivatives (e.g., guar gum, carboxymethyl guar, hydroxypropyl guar, xanthan gum, Artemisia sphaerocephala gum), cellulose and its derivatives (e.g., hydroxymethyl cellulose, carboxymethyl cellulose, carboxymethyl hydroxyethyl cellulose, hydroxyethyl cellulose), synthetic polymers (e.g., polyacrylamide, polyethylene oxide, acrylic acid polymers, polyvinyl alcohol), surfactant-based thickeners, gel-based thickeners (e.g., phenolic resin, guar gum-crosslinker gel systems), clays (e.g., montmorillonite, bentonite).

Regarding Step S2, it is specifically noted that in the method of the present application for energy storage via subterranean formation fractures based on compressed air, the sealing fluid is configured as a fracturing liquid fluid containing sealing substance, enabling step S2 to be integrated into step S1 and performed simultaneously with step S1, or, the sealing fluid is configured as a liquid fluid containing sealing substance and independent of the fracturing fluid, enabling step S2 to be performed independently of step S1. That is to say, step S2 can either be a part of step S1, and upon completion of step S1, step S2 is also completed accordingly, or step S2 is an independent step separate from step S1, that is, after step S1 is implemented, an additional step S2 is carried out.

In some embodiments, the sealing fluid comprises a solid sealing substance (e.g., particles, fibers, polymers) for physically sealing pores and/or micro-formation fractures in the surrounding rock of the formation fractures.

In another embodiment, the sealing fluid comprises a liquid sealing substance to chemically seal pores and/or micro-formation fractures in the surrounding rock of the formation fractures. The liquid sealing substance solidify (e.g., into gels or solids) through one or more of the following mechanisms: chemical reactions between components within the liquid sealing agent, or reactions triggered by contact between different liquid sealing substances, or reactions with formation pore fluids, or phase changes are induced by alterations in salinity, pH, or temperature upon entering the formation. In some embodiments, the fracturing liquid fluid can be configured to contain liquid sealing substances, which enables the sealing of rock pores and/or micro-fractures around the fractures during and/or after the fracturing operation. This eliminates the need for additional separate steps for physical and/or chemical sealing, thereby excellently improving work efficiency and significantly reducing the cost of energy storage based on compressed air.

Post-sealing, lower rock permeability correlates with improved fracture sealing tightness. Preferably, the post-sealing rock permeability does not exceed 0.0001 millidarcy. The impact of sealing substances on permeability can be quantified and evaluated in advance through laboratory experiments, numerical simulations, or molecular modeling.

Furthermore, it will be understood by those skilled in the art that physical sealing particles, which are relatively small (ranging from the micron to nanometer scale), do not seal fractures. As for chemical sealing, chemical fluids may be injected into batches to ensure that the curing reaction occurs only in the pores surrounding the fractures, rather than within the fractures themselves, thereby achieving the objective of sealing the surrounding voids while avoiding blockage of the subterranean fractures.

Due to the cyclic opening and closing of subterranean fractures during repeated energy storage and release cycles (e.g., daily cycles resulting in 365 cycles annually, with a typical operational lifespan exceeding 30 years for compressed air energy storage facilities), fatigue effects may develop at fracture tips. This can lead to micro-fracture formation at fracture tips, causing compressed air leakage and reduced storage efficiency. To mitigate this risk, the fracture tips require modification after Step S2 to prevent micro-fracture initiation. Alternatively, after multiple cycles of Steps S4 and S5, the fracture tips may require modification to repair damage. The modification process for fracture tips comprises the following steps:
sequentially injecting a first fluid and a second fluid into the one or more subterranean formation fractures, and the first fluid comprises at least one liquid polymer and at least one curing agent, and the second fluid is configured as a fluid that does not undergo a curing reaction or polymerization reaction by itself,
after the second fluid displaces the first fluid to the tips of the one or more subterranean formation fractures, ceasing the injection of the second fluid into the one or more subterranean formation fractures, and until the first fluid completes the curing reaction, transitioning from a liquid-state substance to a solid-state substance.

In some embodiments, fracture toughness of the solid-state substance is greater than the fracture toughness of the formation rock in which the one or more subterranean formation fractures are located, and/or tensile strength of the solid-state substance is greater than the tensile strength of the formation rock in which the one or more subterranean formation fractures are located, and/or shear strength of the solid-state substance is greater than the shear strength of the formation rock in which the one or more subterranean formation fractures are located, and/or compressive strength of the solid-state substance is greater than the compressive strength of the formation rock in which the subterranean formation fractures are located, and/or fatigue life of the solid-state substance is greater than the fatigue life of the formation rock in which the one or more subterranean formation fractures are located, and/or fatigue limit of the solid-state substance is greater than the fatigue limit of the formation rock in which the one or more subterranean formation fractures are located, and/or fatigue strength of the solid-state substance is greater than the fatigue strength of the formation rock in which the one or more subterranean formation fractures are located.

Common “liquid polymers” include, but are not limited to: epoxy resin, polyurethane, polyetheramine, liquid natural rubber, liquid polybutadiene, polyimide precursors, polyether ether ketone (PEEK), and the like. Common “curing agents” include, but are not limited to: ethylenediamine, triethylenetetramine, m-phenylenediamine, diaminodiphenylmethane, polyamides, modified cycloaliphatic amines, maleic anhydride, hexahydrophthalic anhydride, methyltetrahydrophthalic anhydride, phenolic modifiers, and the like. Common “curing agents” can be categorized into classes: amines, anhydrides, phenolics, metal salts, imidazoles, polyisocyanates, polysulfides, and the like. Curing reaction time is influenced by factors including: the type of liquid polymer, the type of curing agent; the mixing ratio of liquid polymer to curing agent; temperature conditions.

In other embodiments, the first fluid has a relatively high viscosity. To enable the second fluid to better displace the first fluid in the formation fractures and wellbore, avoid the occurrence of viscous fingering, reduce the residual of the first fluid in areas beyond the fracture tips, and prevent the first fluid and the second fluid from mixing in the wellbore, the ratio M of the viscosity of the first fluid to the viscosity of the second fluid does not exceed 10.

In other embodiments, in order to prevent the Rayleigh-Taylor instability phenomenon caused by the difference in density between the first fluid and the second fluid in the wellbore, as well as the stratification of the first fluid and the second fluid in the formation fractures, the density of the first fluid needs to be the same as or close to that of the second fluid. For example, in some embodiments, the density of the first fluid must not be less than 70% of the density of the second fluid.

In other embodiments, in order to prevent the first fluid and the second fluid from mixing due to turbulent flow caused by excessively high flow rates of the first fluid or the second fluid in the wellbore and formation fractures, the injection flow rate of the second fluid needs to be lower than a threshold flow rate. This ensures that neither the first fluid nor/and the second fluid generate turbulent flow in the wellbore or formation fractures. The threshold flow rate can be calculated using empirical formulas, theoretical models, or numerical simulations based on information such as the hydrodynamic properties of the first fluid and/or the second fluid, the dimensions of the wellbore and fractures, and the surface roughness of the wellbore and fractures. For example, the threshold flow rate is determined by comparing whether the calculated Reynolds number meets the critical value for turbulent flow.

In other embodiments, the step of modifying the fracture tip includes: injecting degradable capsules and a third fluid into the one or more subterranean formation fractures, and the degradable capsules encapsulate at least one reactant, and the third fluid is configured as a fluid that does not undergo a solidification or polymerization reaction itself; after stopping the injection of the degradable capsules, continuing to inject the third fluid to displace the degradable capsules to the tips of the one or more subterranean formation fractures, i.e., completing the displacement work; after the displacing work is completed, the degradable capsules degrade at the fracture tips of the formation fractures, causing the reactants released by the degradable capsules to undergo a curing reaction with each other and/or with the third fluid, so as to form a solid-state substance. Among them, the injection operations of the degradable capsules and the third fluid can both be completed by controlling the injection time and/or injection amount, and their respective injection times and injection amounts can be set through pre-calculation. This ensures that the respective injection operations of the degradable capsules and the third fluid can be effectively completed, and whether the displacement operation is completed can also be judged based on whether the injection operation of the third fluid is completed. For example, the completion of the injection operation of the third fluid can be regarded as the completion of the displacement operation, or a certain moment after the completion of the injection operation of the third fluid can be taken as the sign of the completion of the displacement operation.

In some embodiments, in the step of injecting degradable capsules and a third fluid into the one or more subterranean formation fracture, the density of the degradable capsules is configured to be less than that of the third fluid, such that the degradable capsules aggregate along an upper boundary of the one or more subterranean formation fracture, or, in the step of injecting degradable capsules and a third fluid into the one or more subterranean formation fracture, the density of the degradable capsules is configured to be greater than that of the third fluid, such that the degradable capsules aggregate along a lower boundary of the one or more subterranean formation fracture. After waiting for the degradable capsules to degrade at the top edge (i.e., top tip) or bottom edge (i.e., bottom tip) of the formation fractures, the reactants released by the degradable capsules and/or the reactants and the third fluid undergo a curing reaction to form a solid substance.

In some embodiments, a single degradable capsule can encapsulate different reactants. In other embodiments, different reactants are encapsulated in different degradable capsules. For example, polymer powder and curing agent powder in a dry state may be placed within the same capsule without undergoing a curing reaction. However, after the capsule is injected into the formation fractures and subsequently degrades, the released polymer powder and curing agent powder can undergo a curing reaction upon contact with water.

The reactant contained within the degradable capsule may be in either a liquid or solid state. The degradable capsule may additionally comprise other substances configured to adjust the overall density of the capsule.

In other embodiments, only the height-direction fracture tips or length-direction fracture tips are modified. In other embodiments, due to the subterranean fractures exhibiting complex geometric configurations, multiple fracture tips may be modified accordingly.

In the present application, Step S3 further comprises:
S301, injecting a high-pressure fluid into the target wellbore such that a pressure within the one or more subterranean formation fractures is greater than the fracture closure pressure and less than the fracture propagation pressure, so as to the one or more subterranean formation fractures are in an open and non-propagating state,
S302, sealing the wellhead of the target wellbore,
S303, determining whether the one or more subterranean formation fractures gradually close under a wellhead sealing condition by monitoring the change in pressure at the wellhead and/or in the wellbore over time, thereby determining the air tightness of the formation fractures.

The high-pressure fluid in Step S3 may be a liquid (e.g., fracturing liquid fluid) or gas (e.g., air, helium, nitrogen), i.e., high-pressure fluid comprises liquid high-pressure fluid and/or gas high-pressure fluid. For example, the tightness of the formation fractures mentioned can be judged by the change of the wellhead pressure drop curve over time after the pump is stopped during fracturing operations (at this time, the pressure in the fractures is greater than the formation fracture closure pressure and less than the formation fracture propagation pressure). For instance, if the wellhead pressure remains stable or the pressure drop per unit time is less than a threshold (such as a pressure drop of no more than 0.2 MPa per hour), it indicates that the formation fractures have good tightness. Based on the pressure drop data, the leakage rate of compressed air within a certain period can be calculated. The threshold of pressure drop per unit time can also be determined by giving the threshold of daily leakage rate. If the wellhead pressure drops rapidly or exceeds the set threshold, it indicates that the formation fractures have poor tightness, and fluid leakage causes the fractures to start closing. If the tightness of the formation fractures does not meet the requirements, it is necessary to perform sealing operations again on the rock pores and/or micro-fractures around the formation fractures until the tightness of the formation fractures meets the design requirements.

The wellbore pressure may be measured at wellhead or via downhole pressure gauges or distributed fiber optic sensors.

In a preferred embodiment for sealing tightness testing, steps S301-S303 are first performed based on the high-pressure liquid fluid and then based on the high-pressure gas fluid in sequence. That is to say, the formation fractures are first tested for sealing integrity with a high-pressure liquid fluid (at least once) and then with a high-pressure gas fluid (at least once). Specifically, the formation fractures are first tested for sealing integrity using a high-pressure liquid fluid. The advantage of this approach is that if the sealing test fails, the existing surface liquid injection equipment and liquid storage facilities (such as surface liquid storage tanks, surface reservoirs, and sealing material mixing equipment) can be used to perform another sealing operation on the rock pores and/or microfractures around the formation fractures. Once the sealing test with the liquid fluid passes, a high-pressure gas fluid is then used to conduct the sealing test. This is because gas molecules are smaller and more prone to leakage, and in certain cases, specific physical or chemical sealing measures may exhibit significantly different sealing effects for liquids and gases.

In another specific embodiment of the sealing tightness test, a high-pressure fluid is injected into the target wellbore such that the maximum pressure within the fractures is not less than a test pressure threshold. This threshold is set to be greater than the fracture closure pressure and less than the fracture propagation pressure. The test pressure threshold may be defined as the maximum operational pressure during energy storage within the fractures. This is critical because, in certain scenarios, increasing fracture pressure elevates the risk of re-opening micro-fractures in the surrounding rock. A fracture may pass the sealing tightness test at lower pressures (even while fracture open) but fail at higher pressures due to pressure-induced micro-fracture reactivation.

In another embodiment related to the sealing tightness test, due to the high formation temperature, the thermal expansion of compressed air within the fracture may affect the rate of pressure change at the wellhead and/or within the wellbore. A physical model may be used to calculate and adjust the pressure drop threshold to determine the sealing performance of the subterranean fractures (e.g., by calculating the effect of formation temperature on the density and pressure of compressed air within the fractures). Alternatively, the determination of fracture sealing performance may be conducted after the compressed air within the fractures reaches thermal equilibrium with the formation (i.e. when the temperature of the compressed air within the formation ceases to increase). At that point, the pressure changes over time are analyzed to assess the sealing performance of the fractures. The time required to reach thermal equilibrium may be determined through physical model calculations or by directly measuring the temperature at the wellhead or within the wellbore using downhole thermometers, distributed fiber optic sensors, or other monitoring devices. Specifically, monitoring temperature at the wellhead and/or within the wellbore when the wellhead is sealed, and recording a start time when the temperature at the wellhead and/or within the wellbore no longer changes as time t₀, starting from time t₀ or a time after t₀, determining the air tightness of the one or more subterranean formation fractures based on the change in pressure at the wellhead and/or in the wellbore over time.

In the method disclosed in the embodiments of the present application, in step S5, a power generation device capable of converting the compressive potential energy of the compressed air into electrical energy is provided.

In the method disclosed in the embodiments of the present application, during the energy storage in step S4 and the energy release in step S5, the energy further comprises at least one of the following: the stress potential energy accumulated by the compressed air doing work against the fracture closure pressure, the elastic deformation potential energy accumulated by driving the formation rock to undergo elastic deformation, and the formation thermal energy obtained by the heat exchange between the compressed air in the one or more subterranean formation fractures and the formation rock.

Specifically, during energy storage in Step S4, compressed air is injected into the wellbore, increasing the pressure within the fractures to a level exceeding the fracture closure pressure but remaining below the fracture propagation pressure. This ensures that compressed air continuously enters the fractures, increasing their width without causing fracture extension, thereby inducing elastic deformation of the formation rock and storing elastic deformation potential energy. Simultaneously, the increased pressure within the wellbore and fractures stores compressive potential energy in the compressed air. Additionally, heat exchange between the compressed air and the formation rock enables the absorption of geothermal energy. The wellbore is then sealed to maintain pressure, facilitating energy storage. Upon completion of energy storage, the volume of compressed air contained within the fractures is substantially greater than that retained in the wellbore.

Typically, compressed air needs to be preheated to a temperature between 100 °C and 300 °C before entering the expander for power generation to improve power generation efficiency. When the formation temperature is relatively high, the temperature of the compressed air in the formation fractures will also rise during storage. As a result, the energy consumed for preheating before the subsequent reverse-discharge to the ground and entry into the expander for power generation will be greatly reduced, thereby improving energy storage efficiency. In some embodiments, when the formation temperature is higher than 100 °C, the compressed air does not need to be preheated before entering the expander for power generation, which significantly reduces the operating cost of power generation.

To prevent formation fractures from propagating during energy storage, which could lead to the risk of energy loss and gas leakage, it is necessary to monitor the wellhead pressure during the energy storage process to ensure that the pressure inside the formation fractures is always lower than the formation fracture propagation pressure.

To more accurately calculate the frictional resistance in the wellbore and the pressure of compressed air in the formation fractures, during the energy storage process, that is, during the execution of the aforesaid step S4, it is necessary to monitor the pressure at the wellhead and/or in the wellbore as well as the compressed air flow rate. This is because the frictional resistance of compressed air in the wellbore and fractures is closely related to the compressed air flow rate, and the compressed air flow rate also determines the flow regime (such as laminar flow or turbulent flow). In some embodiments, to calculate the density of compressed air more accurately, it is additionally necessary to monitor the temperature at the wellhead and/or in the wellbore. The temperature in the wellbore can be measured by means of installing downhole thermometers, distributed optical fibers, or other methods.

The method for calculating frictional loss comprises the following steps: Determine wellbore geometric parameters (length, inner diameter, wall roughness) and operational parameters (e.g., inlet pressure, temperature, flow rate). Obtain air density and viscosity at working pressure via reference tables or physical model calculations. Calculate the Reynolds number and determine the flow regime (laminar or turbulent). Determine the friction factor based on the flow regime and calculate frictional loss.

To further mitigate fracture extension risks, a pressure threshold is established, ensuring that the pressure during energy storage does not exceed this threshold. The threshold is set according to the risk of fracture propagation: For high-risk scenarios, the threshold may be set to fracture propagation pressure −1 MPa. For low-risk scenarios, the threshold may be set to fracture propagation pressure −0.5 MPa.

After the completion of step S4, in which compressed air is injected into the wellbore, if there is no energy release demand, the wellbore is sealed to maintain pressure within the wellbore and fractures for energy storage. If there is an energy release demand, compressed air is discharged from the wellbore.

In a particularly preferred embodiment, in step S5, after sealing the wellhead upon monitoring no demand for energy release, the method further comprises a step of monitoring pressure at the wellhead and/or within the wellbore to calculate pressure in the one or more subterranean formation fractures; reverse-discharging the compressed air from the target wellbore when the pressure in the one or more subterranean formation fractures approaches or reaches the formation fracture propagation pressure or a set fracture working pressure threshold.

That is, during the process of sealing the wellbore, it is necessary to monitor the pressure at the wellhead and/or in the wellbore and calculate the formation fracture pressure, so as to ensure that the formation fracture pressure does not exceed the formation fracture propagation pressure or a set threshold. When the formation fracture pressure is close to the formation fracture propagation pressure or reaches the set threshold, it is necessary to reverse-discharge compressed air from the wellbore (regardless of whether there is a demand for energy release), so as to avoid spontaneous propagation of formation fractures. Unlike energy storage using liquids, the temperature rise of compressed air in formation fractures will lead to volume expansion and pressure increase, while the volume of liquids (such as water) is hardly affected by temperature. For example, according to the ideal gas state equation, when the air storage volume remains unchanged, if the temperature increases from 40 degrees Celsius (such as the temperature of compressed air injected into the wellhead) to 80 degrees Celsius (such as the formation temperature where the formation fractures are located), the compressed air pressure inside formation fractures will increase by 12.7%. In some embodiments, when the position where the pressure is measured in the wellbore is very close to the position of the formation fractures, the measured pressure value can be approximately equivalent to the formation fracture pressure value in the calculation.

The flow rate range for compressed air energy storage typically spans 1000 to 4000 cubic meters per minute, significantly exceeding the flow rate range for liquid-based energy storage in subterranean fractures (typically 5 to 10 cubic meters per minute). Consequently, the efficiency of compressed air energy storage is more severely affected by fracture width compared to liquid-based storage. When the width of the fractures is too small, flow resistance increases, substantially reducing energy storage efficiency. At a given flow rate, lower pressure within the fractures corresponds to narrower fracture widths, higher flow velocities, and greater energy losses due to flow frictional loss.

In another embodiment, to enhance energy storage efficiency and reduce flow frictional loss during injection and flowback of compressed air in the subterranean fractures, a residual volume of compressed air is retained in the fractures after energy release in Step S5. This ensures that the fracture pressure remains above the fracture closure pressure and maintains a residual fracture width. Specifically, the step of ensuring the one or more subterranean formation fractures still have a residual fracture width after energy release in step S5, which comprises setting a critical residual fracture width for the one or more subterranean formation fractures, and determining a critical residual compressed air volume based on the set critical residual fracture width, and in step S5, monitoring the remaining volume of the compressed air in the wellbore and its formation fractures during the energy release process, and ending the reverse-discharge when the monitored remaining volume approaches or reaches the critical residual compressed air volume, thereby retaining a residual fracture width in the formation fractures. The remaining volume of compressed air can also be determined by monitoring the accumulative reverse-discharged volume of compressed air.

The critical residual fracture width (and corresponding critical residual compressed air volume) can be determined via physical models or numerical simulations to balance energy storage efficiency and operational capacity (i.e., the volume of air available for power generation). A larger critical residual fracture width retains more compressed air in the fractures, reducing frictional flow losses and improving efficiency, albeit at the expense of operational capacity. In some embodiments, up to 30% of the maximum energy storage capacity is retained as residual compressed air after Step S5. Upon completion of energy release in Step S5, the wellbore may be sealed to maintain pressure and fracture width in the subterranean fractures.

In one embodiment, during energy storage, heat generated by compressing air is transferred via a heat exchanger to a thermal energy storage medium (e.g., water, molten salt, ceramic particles) for retention. When energy release is required for power generation, the stored heat is used to preheat the compressed air entering the expander, thereby reducing reliance on external heat sources. The stored heat may also be utilized for industrial processes, heating, or domestic hot water, enabling thermal energy reuse.

During the energy release process of step S5, the wellbore sealing pressure is reduced to discharge the compressed air in a reverse direction. During the reverse-discharge, at least one of the following may be recovered: the kinetic energy of the compressed air converted from the elastic potential energy stored in the formation rock, the compression potential energy released by the compressed air, and the thermal energy carried by the compressed air.

A predefined power generation system converts at least one of the aforementioned energy forms into electrical energy. The power generation equipment includes, but is not limited to: turbines, expanders, turboexpanders, heat exchangers, and organic Rankine cycle (ORC) systems.

In one embodiment, a turbine is used to convert the kinetic energy of compressed air into electrical energy. In one embodiment, an expander is employed to convert the compressional potential energy of compressed air into electrical energy.

In one embodiment, the expander is equipped with a waste heat recovery system to repurpose heat generated during operation. This recovered heat may be used for applications such as preheating air entering the expander or supplying thermal energy to other industrial processes.

In one embodiment, waste heat generated during the expansion of compressed air is utilized to drive an organic Rankine cycle (ORC) expander, thereby converting thermal energy into electrical energy.

In one embodiment, compressed air is heated prior to entering the expander for power generation.

In one embodiment, due to the elevated temperature of the formation, compressed air heats up while stored in the fractures, eliminating the need for additional preheating during expansion.

In one embodiment, the low thermal conductivity of the formation allows thermal energy from compressed air to be retained within the fractures, eliminating the need for surface-based heat recovery systems.

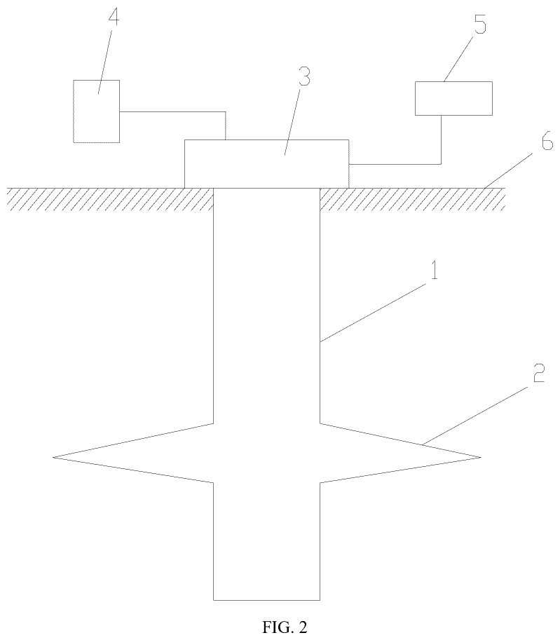

FIG. 2 is a schematic diagram of compressed air energy storage via a sealed subterranean formation fracture according to the present application. As shown in FIG. 2, a subterranean formation fracture 2 is created within a target wellbore 1. A sealing device 3 is arranged at the wellhead of the target wellbore 1. A compressor 4 for supplying compressed air into the target wellbore 1 and a power generation equipment 5 for generating electricity by means of the compressed potential energy accumulated by the compressed air, the kinetic energy of the compressed air converted from the elastic potential energy accumulated by the formation rocks, and the geothermal energy carried by the compressed air when the compressed air is reversely discharged are arranged outside the target wellbore 1 and on the surface 6. As mentioned earlier, the power generation equipment 5 includes but is not limited to one or more of the following: Turbines, Turboexpanders, Expansion machines, Heat exchangers, Organic Rankine Cycle (ORC) power generation systems.

As illustrated in FIG. 2, the system enables both injection and discharge of compressed air through a single target wellbore, thereby significantly reducing investment costs. An energy storage project may comprise multiple wellbores; however, there is no hydraulic communication between the wellbores (i.e., no hydraulic connectivity via fractures or rock pores between individual wellbores). Each sealed fracture connected to a wellbore remains isolated from sealed fractures associated with other wellbores. Consequently, the energy storage and discharge operations of each wellbore are independent and unaffected by those of other wellbores.

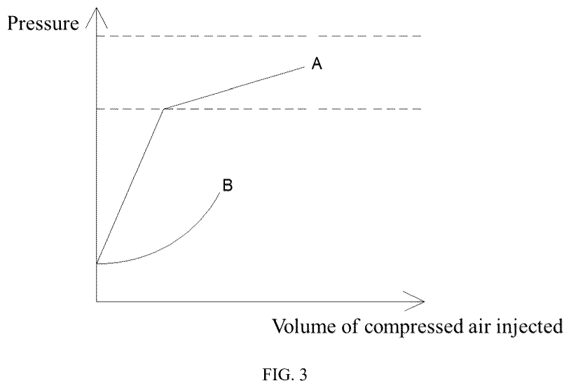

FIG. 3 shows a comparison between conventional compressed air energy storage (utilizing natural or man-made subsurface cavities) and compressed air energy storage via sealed subterranean formation fractures. In FIG. 3, the upper dashed line represents the fracture propagation pressure of the subterranean formation, while the lower dashed line denotes the fracture closure pressure. Curve A represents the relationship between injected compressed air volume and pressure during the energy storage process using the sealed subterranean fractures of the present application, whereas Curve B corresponds to the relationship between injected compressed air volume and pressure in conventional compressed air storage systems utilizing natural or man-made underground cavities. As demonstrated in the figure, compared to conventional methods employing natural or man-made underground cavities for compressed air energy storage, the present application achieves higher storage pressure at the same injected volume through sealed subterranean fractures, thereby enabling greater energy storage density.

Traditional compressed air energy storage systems are constrained by the pressure limits of underground cavities, which cannot exceed the subterranean fracturing pressure. For instance, underground salt cavern storage systems typically operate at pressures ranging from approximately 7 MPa to 12 MPa. In contrast, the maximum storage pressure achievable in subterranean fractures far exceeds that of salt caverns, significantly enhancing energy storage density. For example, at a depth of 3,000 meters, if the minimum principal stress of a subterranean fracture is 50 MPa and the fracture propagation pressure is 55 MPa, the operational storage pressure range for fracture-based energy storage would be 50 MPa to 55 MPa. Generally, deeper subterranean fractures exhibit higher fracture closure pressures, enabling greater energy storage pressures.

Furthermore, conventional compressed air energy storage systems only store the compressive potential energy of air. In contrast, the proposed method utilizing sealed subterranean fractures additionally captures elastic strain energy from rock deformation (due to increased fracture width) and stress potential energy from overcoming fracture closure pressure during compression. This further enhances energy storage density. Notably, the stress potential energy accumulated by overcoming fracture closure pressure significantly reduces the pressure drop per unit volume of air discharged during the discharging phase.

The present application further discloses a system for implementing the method of the first aspect, comprising: a fracturing unit, a sealing fluid injection unit, an air tightness test unit, an energy storage unit, and an energy release unit. The fracturing unit configured to inject a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via formation fractures. The sealing fluid injection unit configured to injecting a sealing fluid into the subterranean formation fractures to physically and/or chemically seal pores and/or micro-fractures in the surrounding rock of the one or more subterranean formation fractures. The air tightness test unit configured to conduct an air tightness test based on wellhead sealing on the target wellbore to evaluate the air tightness of the subterranean formation fractures. The energy storage unit configured to inject compressed air into the target wellbore such that the post-injection pressure of the one or more subterranea formation fractures is greater than the fracture closure pressure and less than the fracture propagation pressure for energy storage, which at least includes the compressive potential energy accumulated by the compressed air due to the pressure increase in the overall space formed by the target wellbore and the one or more subterranea formation fractures. The energy release unit configured to reverse-discharge the compressed air and obtain at least the compressive potential energy released by the compressed air during the reverse-discharge process.

The air tightness test unit comprises a high-pressure fluid injection unit, a sealing unit and a pressure monitoring and determination unit, the high-pressure fluid injection unit configured to inject high-pressure fluid into the target wellbore such that the pressure in the formation fractures is greater than the fracture closure pressure and less than the fracture propagation pressure, so as to keep the formation fractures open but not expanding, the sealing unit configured to seal the wellhead of the target wellbore, the pressure monitoring and determination unit configured to monitor the wellhead or wellbore pressure of the target wellbore, and determine whether the one or more subterranean formation fractures gradually close under the wellhead sealing condition by monitoring the change in pressure at the wellhead and/or in the wellbore over time, thereby determining the tightness of the formation fractures. In the system of the present application, the sealing fluid is configured as a fracturing fluid containing sealing substances, enabling the sealing fluid injection unit to be integrated into the fracturing unit and complete the work along with the fracturing operation, or the sealing fluid is configured as a fluid containing sealing substances and independent of the fracturing fluid, enabling the sealing fluid injection unit to work independently of the fracturing unit.

In another embodiment of the system, a compressed air flow rate monitoring unit is included, configured to monitor the compressed air flow rate during energy storage and/or release. This is because the frictional loss of compressed air in the wellbore and fractures is closely related to its flow rate, which also determines the flow regime (e.g., laminar or turbulent). In further embodiments, to accurately calculate compressed air density, the system may also monitor wellhead and/or wellbore temperature using temperature monitoring devices (e.g., downhole thermometers or distributed fiber optic sensors).

In another embodiment of the system, a compressed air flow monitoring unit is further included, which is configured to monitor the flow rate of compressed air during the energy storage and/or energy release processes. This is because the frictional resistance of compressed air within the wellbore and fractures is closely related to the flow rate of the compressed air, which also determines the flow regime (e.g., laminar or turbulent flow). In yet another embodiment, for more accurate calculation of the density of the compressed air, it is additionally necessary to monitor the temperature at the wellhead and/or within the wellbore. This can be achieved by incorporating a temperature monitoring device. For example, the temperature within the wellbore can be measured by installing downhole thermometers or using distributed fiber optic sensors.

In another embodiment of the system, a critical residual fracture width setting unit is included to define the critical residual fracture width of the subterranean fractures. The computational unit or control unit is further configured to determine the critical residual compressed air volume based on this width. The compressed air flow rate monitoring unit also monitors the remaining volume of compressed air in the wellbore and fractures or total released compressed air volume during energy release. When the remaining volume approaches or reaches the critical residual volume, the control unit terminates expel to maintain the residual fracture width.

In another embodiment of the system, power generation equipment is further included, which is capable of converting at least one of the following into electrical energy: the kinetic energy of compressed air derived from the elastic potential energy accumulated in the formation rock, the compression potential energy released by the compressed air, and the thermal energy carried by the compressed air. The power generation equipment includes but is not limited to: Turbines; Turboexpanders; Expanders; Heat exchangers; Organic Rankine cycle (ORC) systems. Wherein, a turbine is used to convert the kinetic energy of compressed air into electrical energy. In one embodiment, an expander is utilized to convert the compression potential energy of compressed air into electrical energy.

In another embodiment of the system, the expander is equipped with a waste heat recovery system to repurpose heat generated during operation (e.g., preheating incoming air or supplying thermal energy to other processes).

In another embodiment of the system, waste heat generated during compressed air expansion drives an organic Rankine cycle (ORC) expander to convert thermal energy into electricity.

In another embodiment of the system, compressed air is heated before entering the expander for power generation.

In another embodiment of the system, due to the elevated formation temperature, compressed air heats up while stored in the fractures, eliminating the need for preheating during expansion.

In yet another embodiment of the system, the low thermal conductivity of the formation retains thermal energy within the fractures, eliminating the need for surface-based heat recovery systems.

It should be specifically noted that the sealing fluid injection unit is configured to be integrated into the fracturing unit or independent of the fracturing unit. Herein, the so-called “integration” means that no additional sealing fluid injection unit is provided, and the functions and characteristics of the sealing fluid injection unit are realized through the fracturing unit. That is, the functions of the sealing fluid injection unit can be directly realized based on the fracturing unit, so that the fracturing unit includes the functions to be realized by the sealing fluid injection unit, and thus the fracturing unit exists as a fracturing and sealing fluid injection unit. In other embodiments, the sealing fluid injection unit can exist as a unit with independent functions, so as to implement chemical sealing on its own. All functional and technical features described in the method of the first aspect are fully applicable to the system disclosed in the present application and thus are not redundantly reiterated here.

For ease of description, spatially relative terms such as “above,” “over,” “on the surface of,” or “upper” may be used to define the positional relationship between components or features as depicted in the figures. It should be understood that these terms encompass orientations beyond those explicitly illustrated in the drawings. For example, if a component in the figures is inverted, a feature described as “above” or “over” another component would instead be positioned “below” or “under” it. Thus, the exemplary term “above” inherently includes both “above” and “below” orientations. Components may also be positioned in other configurations, and the spatially relative terminology used herein shall be interpreted accordingly.

It is to be noted that the terms used herein are solely for the purpose of describing specific embodiments and are not intended to limit the exemplary embodiments of the present application. Unless the context clearly indicates otherwise, the singular form is intended to include the plural form. Moreover, it is to be understood that when the terms “comprising” and/or “including” are used in this specification, they indicate the presence of features, steps, operations, devices, components, and/or any combinations thereof.

It is further noted that the terms “first,” “second,” and the like, as used in the specification, claims, and accompanying drawings of the present application, are employed merely to distinguish between similar objects and are not necessarily intended to denote any particular order or sequence. It should be appreciated that such designations may be interchanged under appropriate circumstances so that the embodiments of the present application may be implemented in an order different from that illustrated or described herein. In addition, the terms “comprising” and “having,” and any variations thereof, are intended to be interpreted in an inclusive manner. For example, a process, method, system, product, or apparatus comprising a series of steps or units is not limited to the steps or units explicitly recited but may include other steps or units that are inherent to the process, method, product, or apparatus even if they are not explicitly listed.

The foregoing embodiments are illustrative and not restrictive. Those skilled in the art will recognize that the application may be modified, substituted, or improved without departing from its spirit and scope. All such variations fall within the protection of the appended claims.

Finally, it should be noted that the disclosed embodiments exemplify the technical solutions of the application and are not limiting. Even after detailed descriptions of preferred embodiments, ordinary skilled artisans may modify or substitute the disclosed systems/methods without deviating from the application's principles, and such modifications are encompassed by the claims.

What is claimed is:

1. A method for energy storage via subterranean formation fractures based on compressed air, wherein the method comprises the steps of:
S1, injecting a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via the one or more subterranean formation fractures,
S2, injecting a sealing fluid into the one or more subterranean formation fractures to physically and/or chemically seal pores and/or micro-fractures in the surrounding rock of the one or more subterranean formation fractures,
S3, conducting an air tightness test based on wellhead sealing on the target wellbore to determine air tightness of the one or more subterranean formation fractures,
S4, injecting compressed air into the target wellbore and the one or more subterranean formation fractures, and making post-injection pressure of the one or more formation fractures greater than a fracture closure pressure but less than a fracture propagation pressure to store energy, which at least includes compressive potential energy accumulated by the compressed air due to pressure increase in overall space formed by the target wellbore and the one or more subterranean formation fractures,
S5, monitoring whether there is a demand for energy release, if no demand exists, sealing the wellhead; if demand exists, reverse-discharging the compressed air, and obtaining at least the compressive potential energy released by the compressed air during the reverse-discharge process,
wherein the sealing fluid is configured as a fracturing liquid fluid containing sealing substance, enabling step S2 to be integrated into step S1 and performed simultaneously with step S1, or the sealing fluid is configured as a liquid fluid containing sealing substance and independent of the fracturing fluid, enabling step S2 to be performed independently of step S1.

2. The method according to claim 1, wherein a thickening agent is added to the fracturing liquid fluid, and the thickening agent comprises at least one selected from the group consisting of: at least one natural polymer or its derivatives, at least one cellulose or its derivatives, at least one synthetic polymer, at least one surfactant-based thickener, at least one gel-based thickener, and at least one clay.

3. The method according to claim 1, wherein the sealing substance comprises a solid sealing substance for physically sealing pores and/or micro-formation fractures in the surrounding rock of the formation fractures,
and/or, the sealing substance comprises a liquid sealing substance configured to undergo a curing or gelation reaction between its own components, or between different liquid sealing substances upon contact, or with fluids in the pores and/or micro-fractures in the surrounding rock of the one or more subterranean formation fractures upon contact, or to undergo a curing or gelation reaction due to changes in salinity, pH, or temperature after entering the subterranean formation, so as to chemically seal the pores and/or micro-fractures in the surrounding rock of the subterranean formation fractures.

4. The method according to claim 3, wherein the sealing substance is directly added to corresponding fluid constituting the sealing fluid,
or, the sealing material in fluid is added to the corresponding fluid constituting the sealing fluid in a manner that at least part of the sealing substance is encapsulated in degradable capsule.

5. The method according to claim 1, wherein step S3 comprises:
S301, injecting a high-pressure fluid into the target wellbore such that a pressure within the one or more subterranean formation fractures is greater than the fracture closure pressure and less than the fracture propagation pressure, to the one or more subterranean formation fractures are in an open and non-propagating state,
S302, sealing the wellhead of the target wellbore,
S303, determining whether the one or more subterranean formation fractures gradually close under a wellhead sealing condition by monitoring the change in pressure at the wellhead and/or in the wellbore over time, thereby determining the air tightness of the formation fractures.

6. The method according to claim 5, wherein in the step S3, the high-pressure fluid comprises a high-pressure liquid fluid and a high-pressure gas fluid, steps S301-S303 are first performed based on the high-pressure liquid fluid and then based on the high-pressure gas fluid in sequence.

7. The method according to claim 6, wherein in the step S301, a test pressure threshold is set, which is configured to be greater than the fracture closure pressure and less than the fracture propagation pressure, such that after the high-pressure fluid is injected into the one or more subterranean formation fractures, a maximum pressure in formation fractures is not lower than the test pressure threshold and less than the fracture propagation pressure.

8. The method according to claim 5, wherein in step S303, the determination of air tightness of the one or more subterranean formation fractures comprises:
monitoring temperature at the wellhead and/or within the wellbore when the wellhead is sealed, and recording a start time when the temperature at the wellhead and/or within the wellbore no longer changes as time t₀,
starting from time t₀ or a time after t₀, determining air tightness of the one or more subterranean formation fractures based on the change in pressure at the wellhead and/or in the wellbore over time.

9. The method according to claim 1, wherein during execution of step S4, the method further comprises a step of monitoring pressure at the wellhead and/or within the wellbore and a flow rate of compressed air.

10. The method according to claim 1, wherein in step S5, after sealing the wellhead upon monitoring no demand for energy release, the method further comprises a step of monitoring pressure at the wellhead and/or within the wellbore to calculate pressure in the one or more subterranean formation fractures,
reverse-discharging the compressed air from the target wellbore when the pressure in the one or more subterranean formation fractures approaches or reaches the formation fracture propagation pressure or a set fracture working pressure threshold.

11. The method according to claim 1, wherein the method further comprises a step of ensuring the one or more subterranean formation fractures still have a residual fracture width after energy release in step S5, which comprises:
setting a critical residual fracture width for the one or more subterranean formation fractures,
determining a critical residual compressed air volume based on the set critical residual fracture width,
in step S5, monitoring the remaining volume of the compressed air in the wellbore and its formation fractures during the energy release process, and ending the reverse-discharge when the monitored remaining volume approaches or reaches the critical residual compressed air volume, thereby retaining a residual fracture width in the formation fractures.

12. The method according to claim 1, wherein in step S5, a power generation device capable of converting the compressive potential energy of the compressed air into electrical energy is provided.

13. The method according to claim 1, wherein during the energy storage in step S4 and the energy release in step S5, the energy further comprises at least one of the following: the stress potential energy accumulated by the compressed air doing work against the fracture closure pressure, the elastic deformation potential energy accumulated by driving the formation rock to undergo elastic deformation, and the formation thermal energy obtained by the heat exchange between the compressed air in the one or more subterranean formation fractures and the formation rock.

14. The method according to claim 1, wherein the method further includes the step of modifying tips of the one or more subterranean formation fractures, comprising:
sequentially injecting a first fluid and a second fluid into the one or more subterranean formation fractures, and the first fluid comprises at least one liquid polymer and at least one curing agent, and the second fluid is configured as a fluid that does not undergo a curing reaction or polymerization reaction by itself,
after the second fluid displaces the first fluid to the tips of the one or more subterranean formation fractures, ceasing the injection of the second fluid into the one or more subterranean formation fractures, and until the first fluid completes the curing reaction, transitioning from a liquid-state substance to a solid-state substance.

15. The method according to claim 14, wherein fracture toughness of the solid-state substance is greater than the fracture toughness of the formation rock in which the one or more subterranean formation fractures are located, and/or tensile strength of the solid-state substance is greater than the tensile strength of the formation rock in which the one or more subterranean formation fractures are located, and/or shear strength of the solid-state substance is greater than the shear strength of the formation rock in which the one or more subterranean formation fractures are located, and/or compressive strength of the solid-state substance is greater than the compressive strength of the formation rock in which the subterranean formation fractures are located, and/or fatigue life of the solid-state substance is greater than the fatigue life of the formation rock in which the one or more subterranean formation fractures are located, and/or fatigue limit of the solid-state substance is greater than the fatigue limit of the formation rock in which the one or more subterranean formation fractures are located, and/or fatigue strength of the solid-state substance is greater than the fatigue strength of the formation rock in which the one or more subterranean formation fractures are located.

16. The method according to claim 14, wherein a ratio M of the viscosity of the first fluid to the viscosity of the second fluid does not exceed 10.

17. The method according to claim 14, wherein density of the first fluid is no less than 70% of density of the second fluid.

18. The method according to claim 1, wherein the method further comprises a step of modifying tips of the one or more subterranean formation fractures, comprising:
injecting degradable capsules and a third fluid into the one or more subterranean formation fractures, and the degradable capsules encapsulate at least one reactant, and the third fluid is configured as a fluid that does not undergo a solidification or polymerization reaction itself,
after stopping the injection of the degradable capsules, continuing to inject the third fluid to displace the degradable capsules to the tips of the one or more subterranean formation fractures,
after the displacing work is completed, the degradable capsules degrade at the fracture tips of the formation fractures, causing the reactants released by the degradable capsules to undergo a curing reaction with each other and/or with the third fluid, so as to form a solid-state substance.

19. The method according to claim 18, wherein in the step of injecting degradable capsules and a third fluid into the one or more subterranean formation fracture, the density of the degradable capsules is configured to be less than that of the third fluid, such that the degradable capsules aggregate along an upper boundary of the one or more subterranean formation fracture,
or, in the step of injecting degradable capsules and a third fluid into the one or more subterranean formation fracture, the density of the degradable capsules is configured to be greater than that of the third fluid, such that the degradable capsules aggregate along a lower boundary of the one or more subterranean formation fracture.

20. The method according to claim 18, wherein a single degradable capsule can encapsulate different reactants, or different reactants are encapsulated in different degradable capsules.

21. A system for implementing the method according to claim 1, wherein comprising:
a fracturing unit configured to inject a fracturing liquid fluid into a target wellbore to perform hydraulic fracturing, thereby creating one or more subterranean formation fractures and/or reopening existing one or more subterranean formation fractures, and the target wellbore is configured as an independent wellbore that is not hydraulically connected to other wellbores via formation fractures,
a sealing fluid injection unit configured to injecting a sealing fluid into the subterranean formation fractures to physically and/or chemically seal pores and/or micro-fractures in the surrounding rock of the one or more subterranean formation fractures,
an air tightness test unit configured to conduct an air tightness test based on wellhead sealing on the target wellbore to evaluate the air tightness of the subterranean formation fractures, the air tightness test unit comprises:
a high-pressure fluid injection unit configured to inject high-pressure fluid into the target wellbore such that the pressure in the formation fractures is greater than the fracture closure pressure and less than the fracture propagation pressure, so as to keep the formation fractures open but not expanding,
a sealing unit configured to seal the wellhead of the target wellbore,
a pressure monitoring and determination unit configured to monitor the wellhead or wellbore pressure of the target wellbore, and determine whether the one or more subterranean formation fractures gradually close under the wellhead sealing condition by monitoring the change in pressure at the wellhead and/or in the wellbore over time, thereby determining the tightness of the formation fractures,
an energy storage unit configured to inject compressed air into the target wellbore such that the post-injection pressure of the one or more subterranea formation fractures is greater than the fracture closure pressure and less than the fracture propagation pressure for energy storage, which at least includes the compressive potential energy accumulated by the compressed air due to the pressure increase in the overall space formed by the target wellbore and the one or more subterranea formation fractures,
an energy release unit configured to reverse-discharge the compressed air and obtain at least the compressive potential energy released by the compressed air during the reverse-discharge process,
wherein the sealing fluid is configured as a fracturing fluid containing sealing substances, enabling the sealing fluid injection unit to be integrated into the fracturing unit and complete the work along with the fracturing operation, or the sealing fluid is configured as a fluid containing sealing substances and independent of the fracturing fluid, enabling the sealing fluid injection unit to work independently of the fracturing unit.
